(19) United States
(12) Patent Application Publication
(10) Pub. No.: US 2007/0019270 A1
(43) Pub. Date: Jan. 25, 2007

(54) Scanning apparatus capable of filtering off a holographic picture

(75) Inventors: Zhu-Gang Wang, Suzhou (CN); Xin Xue, Suzhou (CN)

Correspondence Address: BIRCH STEWART KOLASCH & BIRCH, PO BOX 747, FALLS CHURCH, VA, 22040-0747, US

(73) Assignee: Avision Inc.

(21) Appl. No.: 11/488,610

(22) Filed: Jul. 19, 2006

(30) Foreign Application Priority Data
Jul. 19, 2005 (TW) 94124415

(51) Int. Cl. G02B 26/08

(52) U.S. Cl. 359/196; 359/896

(57) ABSTRACT

A scanning apparatus for scanning a hologram is capable of filtering off a holographic picture in the hologram. The hologram includes an image layer having an image to be scanned and a laser layer having the holographic picture. The laser layer has a maximum penetrable incidence. Light with an incidence larger than the maximum penetrable incidence fails to pass through due to light reflection so as to prohibit the image light of the image layer from light transmission. The scanning apparatus includes a load platform and a chassis. The load platform is used for placing the hologram thereon. Besides, the chassis includes a light source for emitting a light. When the scanning apparatus performs scanning, light penetrates the image layer to reflect the image to be scanned and further penetrates the laser layer. After a signal processing procedure, a scanned image is obtained without being influenced by the holographic picture.

This application claims the benefit of Taiwan application Serial No. 94124415, filed Jul. 19, 2005, the subject matter of which is incorporated herein by reference.

### BACKGROUND OF THE INVENTION

1. Field of the Invention

The invention relates in general to a scanning apparatus, and more particularly to a scanning apparatus capable of filtering off a holographic picture.

2. Description of the Related Art

Holography is a kind of stereo-photography after the laser technique is presented to the public and booming since the 1960's. In the 1970's, the holograms can be manufactured in a large scale by mold pressing. Holography becomes a frequently used technique for anti-counterfeiting and is thus successively applied in credit cards, identity documents and negotiable securities. Holograms have advantages of easy to identify, difficult to counterfeit, and capable of mass-producing.

The technical feature of holography for anti-counterfeiting is offering stereographs, which are different from the plane images of printing, painting and photographing. Under the illumination of the white light emitted at an inclined angle, the holograms can create an animated stereograph, which is quite impressive.

The holographic picture is formed by emitting a diverged laser beam by scattering through a transparent holographic plastic medium. A part of the laser beam acts as reference beam, another part of the laser beam acts as object beam, which passes through the medium and back to the medium after being scattered by an object. After the reference beam and the object beam interfere, multi-layer surfaces with interference stripes are formed in the medium. Therefore, the medium film has multi-layer semiopaque reflection surfaces produced inside the medium after being processed. After a white light is transmitted to the holographic picture, the light is reflected by the multi-layer semiopaque reflection surfaces so that a virtual image of the object can be viewed. The virtual image is a reflected holographic picture; that is so called “holographic picture”.

Appendix 1 shows an identity card using holography. The identity card is made by directly mold pressing the holographic picture onto the transparent film and then covering the transparent film onto the front side of the whole identity card.

Under the illumination of the light, not only the content on the front side of the identity card but also the holographic picture with a pattern of “Great Wall” and a word of “CHINA” on the transparent film can be seen when observing the front side of the identity card. The holographic picture covering the identity card offers a solution in protecting the identity card from counterfeiting. However, when scanning the identity card, the holographic picture will be scanned along with the content of the identity card and captured to the optical sensing unit. As a result, the scanned image contains both of the content of the identity card and the holographic picture, thereby lowering the image scanning quality.

### SUMMARY OF THE INVENTION

It is therefore an object of the invention to provide a scanning apparatus capable of filtering off a holographic picture in a hologram for preventing the scanned image from being overlaid with the holographic picture so that the scanned image is clear and distinguishable.

The invention achieves the above-identified object by providing a scanning apparatus capable of filtering off a holographic picture in a hologram when scanning the hologram. The hologram includes an image to be scanned and the holographic picture. Under the normal visual effect, the image is overlaid with the holographic picture. The holographic picture has a maximum penetrable incidence (Imax). The scanning apparatus comprises a load platform and a chassis. The load platform is for placing the hologram thereon and made of a transparent material such as glass. The chassis comprises a light signal sensing unit capable of obtaining a scanning signal. Besides, the chassis comprises a light source for emitting a light. The light passes through a scanned glass of the load platform and projects on the hologram with a scanning incidence (F) to penetrate the image layer to reflect the image to be scanned and further penetrate the laser layer to absorb the image to be scanned by the light signal sensing unit. The scanning incidence (F) is must smaller than the maximum scanning incidence (Fmax) due to the optical path design of the chassis; that is, F<Fmax.

The invention achieves the above-identified object by further providing a scanning apparatus capable of filtering off a holographic picture in a hologram. The scanning apparatus is used for scanning the hologram or for scanning a picture. The definition of the hologram is the same as before. The picture includes an image to be scanned. Wherein a hologram includes a maximum penetrable incidence (Imax). The scanning apparatus comprises a first load platform, a second load platform, and a chassis. The first load platform is for placing the picture thereon and allows the light pass through. The second load platform disposed above the first load platform is for placing the hologram thereon and also allows the light pass through. The chassis comprises a light source for emitting a light. When a user scans the normal picture, the picture is placed on the first load platform, and the light penetrates the first load platform and the picture with a first scanning incidence (F1) so that the image to be scanned is reflected. The first scanning incidence (F1) is smaller than a first maximum scanning incidence (Fmax1); that is, F1<Fmax1. When the user scans the hologram, the hologram is placed on the second load platform, the light penetrates the second load platform and the hologram with a second scanning incidence (F2) so that the image to be scanned is reflected. The second scanning incidence (F2) is smaller than a second maximum scanning incidence (Fmax2), and the second maximum scanning incidence (Fmax2) is smaller than the maximum penetrable incidence (Imax); that is F2<Fmax2<Imax. Therefore, the second scanning incidence (F2) is smaller than the maximum penetrable incidence (Imax) and the light penetrates the hologram to reflect the image to be scanned without reflecting the holographic picture.

Moreover, the second load platform can be designed to be liftable or detachable. When scanning the hologram, the user lifts the liftable second load platform or attaches the detachable second load platform to be positioned above the first load platform so that the second scanning incidence (F2) is smaller than the maximum penetrable incidence (Imax) and the light penetrates the hologram to reflect the image to be scanned without reflecting the holographic picture.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 shows the optical path of a scanning apparatus capable of filtering off a holographic picture according to a first embodiment of the invention.

FIG. 2 shows the optical path of a scanning apparatus capable of filtering off a holographic picture according to a second embodiment of the invention.

### DETAILED DESCRIPTION OF THE INVENTION

The holographic picture in the hologram can be reflected at a particular inclined angle so as to have a maximum penetrable incidence. On the basis of the property of holographic picture, the holographic picture in the hologram can be displayed under the slanted illumination of the light emitted, the scanning apparatus according to this invention is to control the incidence of light for being smaller than the maximum penetrable incidence, thereby directly filtering off the holographic picture in the hologram while scanning.

### FIRST EMBODIMENT

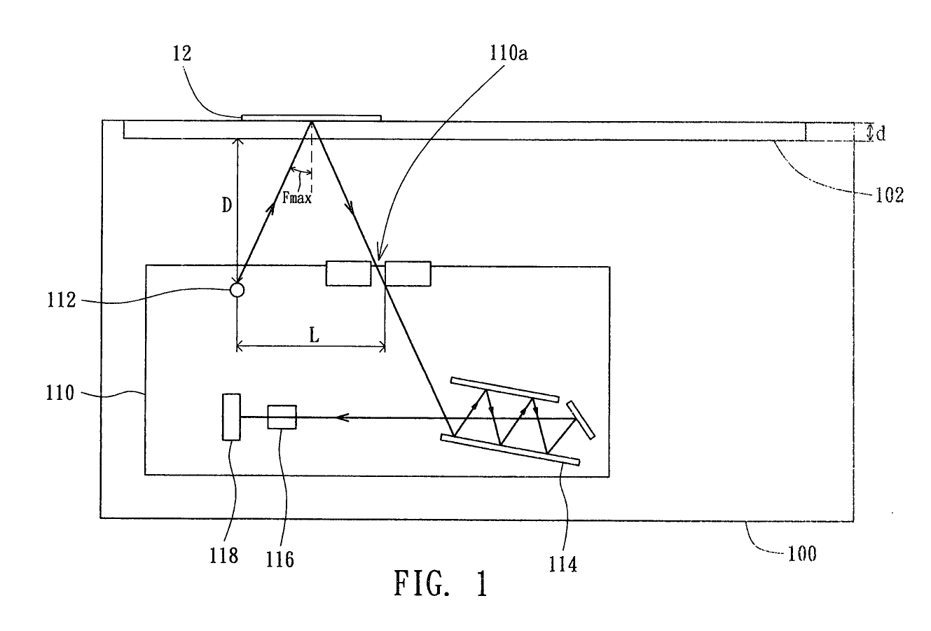

Referring to FIG. 1, the optical path of a scanning apparatus capable of filtering off a holographic picture according to a first embodiment of the invention is shown. The scanning apparatus capable of filtering off a holographic picture at least includes a load platform 102 and a chassis 110. The load platform 102 is for placing a hologram 12 thereon and can be a glass, an acrylic sheet, or a flat board made of other transparent material. The chassis 110 includes a light source 112 for emitting a light. The hologram 12 includes an image to be scanned and the holographic picture. The holographic picture has a maximum penetrable incidence (Imax). Once the incidence of light of the scanning apparatus is larger than the maximum penetrable incidence (Imax) of the holographic picture, the holographic picture in the hologram 12 can be reflected. On the contrary, when the incidence of light of the scanning apparatus is controlled to be smaller than the maximum penetrable incidence (Imax), the light can penetrate the laser layer to reflect the signal of the image layer and further penetrate the laser layer to arrive the chassis. Therefore, the scanning apparatus is able to directly filter off a holographic picture in the hologram while scanning by controlling the incidence of light so that the scanned image is obtained without being influenced by the holographic picture.

As shown in FIG. 1, the light source 112 is disposed in the chassis 110. The chassis 110 has an entrance pupil 110a and further includes a reflection mirror set 114, a lens 116, and an image sensing unit 118. The light source 112 and the entrance pupil 110a are spaced by a first distance L, the light source 112 and the load platform 102 are spaced by a second distance D, and the load platform 102 has a thickness d.

When the light source 112 emits a light, the light penetrates the load platform 102 and the hologram 12 with a scanning incidence F. The largest effective incidence with which the light is reflected by the hologram 12 and able to pass through the entrance pupil 110a is defined as the maximum scanning incidence Fmax. Any light with an incidence larger than the maximum scanning incidence Fmax will deviate from the entrance pupil 110a after being reflected so that the projection of the emitted light fails to form any image in the image sensing unit 118. Thus, the scanning incidence F is necessary to be smaller than the maximum scanning incidence Fmax; that is,
F<Fmax (formula 1).

Without regarding to the refractive index of the load platform 102, the maximum scanning incidence Fmax is substantially equal to arctan[L/2(D+d)]; that is,
Fmax□arctan[L/2(D+d)]

It can be known from these formulas, during the manufacturing process of the scanning apparatus, the maximum scanning incidence Fmax can be controlled to be less than the maximum penetrable incidence Imax by decreasing the first distance L between the light source 112 and the entrance pupil 110a, increasing the second distance D between the light source 112 and the load platform 102, or increasing the thickness d of the load platform 102. Thus, the scanning apparatus according to the invention controls the maximum scanning incidence Fmax to be less than the maximum penetrable incidence Imax by means of the structural design; that is,
Fmax|max (formula 2)

The following formula A can be induced from the above mentioned formula 1 and formula 2:
F<Fmax<Imax (formula A)

Therefore, it can be seen from the formula A, the light with the scanning incidence F smaller than the maximum penetrable incidence Imax does not reflect the holographic picture. Then the light with scanning incidence F even smaller than the maximum scanning incidence Fmax reflects the image to be scanned, passes through the entrance pupil 110a to enter the chassis 100 and reach the reflection mirror set 114, and is then reflected by the reflection mirror set 114 and focused by the lens 116 sequentially so that the image to be scanned is formed in the image sensing unit 118.

### SECOND EMBODIMENT

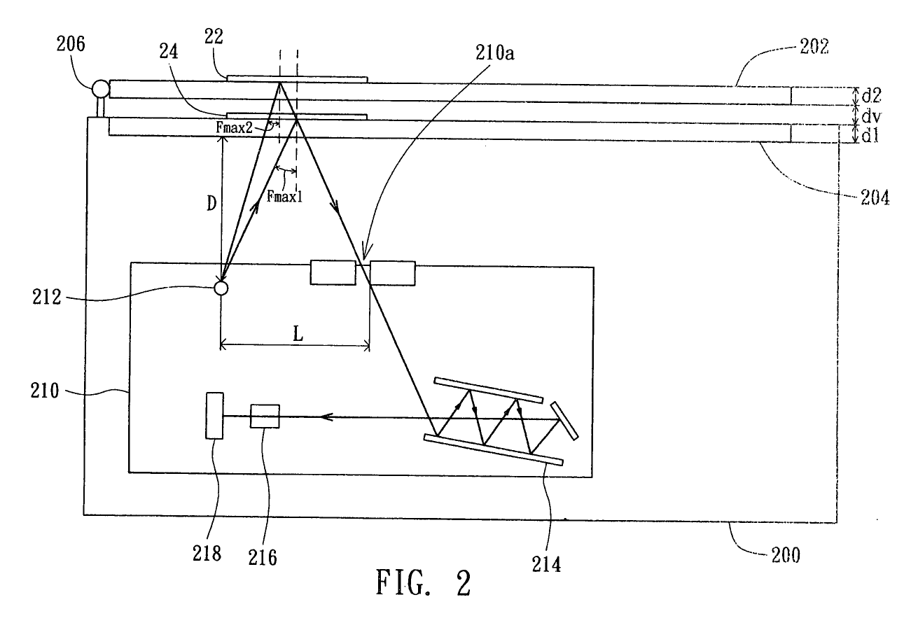

Referring to FIG. 2, the optical path of a scanning apparatus capable of filtering off a holographic picture according to a second embodiment of the invention is shown. The scanning apparatus capable of filtering off a holographic picture at least includes a first load platform 204, a second load platform 202 and a chassis 210. The second load platform 202 is disposed above the first load platform 204 for placing a hologram 22 thereon and can be a glass, an acrylic sheet, or a flat board made of other transparent material. The first load platform 204 is for placing a general picture different from the hologram thereon and can be a further glass, a further acrylic sheet, or a further flat board made of other transparent material. The chassis 210 includes a light source 212 for emitting a light. The hologram 22 includes an image to be scanned and the holographic picture while the general picture 24 includes a further image to be scanned. The holographic picture has a maximum penetrable incidence Imax. As long as the scanning incidence F2 is larger than the maximum penetrable incidence Imax, the holographic picture in the hologram will also be reflected so the light fails to penetrate the laser layer. As shown in FIG. 2, the light source 212 is disposed in the chassis 210. The chassis 210 has an entrance pupil 210a and further includes a reflection mirror set 214, a lens 216, and an image sensing unit 218. The light source 212 and the entrance pupil 210a are spaced by a first distance L, the light source 212 and the first load platform 202 are spaced by a second distance D, the first load platform 204 has a first thickness d1, the second load platform 204 has a second thickness d2, and the second load platform 202 and the first load platform 204 are spaced by an adjustable distance dv.

When the user scans the general picture 24, the general picture 24 is placed on the first load platform 204. When the light source 212 emits a light, the light penetrates the first load platform 204 and the general picture 24 with a scanning incidence F1. The largest effective incidence with which the light is reflected by the general picture 24 and able to pass through the entrance pupil 210a of the chassis 210 is defined as the first maximum scanning incidence Fmax1. Any light with an incidence larger than the first maximum scanning incidence Fmax1 will deviate from the entrance pupil 210a after being reflected so that the projection of the emitted light fails to form any image in the image sensing unit 218. Thus, considering the optical path design, the scanning incidence F1 is necessary to be smaller than the maximum scanning incidence Fmax1; that is,
F<Fmax1 (formula 3).

Without regarding to the refractive index of the first load platform 204, the first maximum scanning incidence Fmax1 is substantially equal to arctan[L/2(D+d1)]; that is,
Fmax1<arctan[L/2(D+d1)]

It can be known from these formulas, when the first distance L between the light source 212 and the entrance pupil 210a and the second distance D between the light source 212 and the first load platform 204 are fixed values, the first maximum scanning incidence Fmax1 can be controlled to be less than the maximum penetrable incidence Imax by adjusting the thickness d1 of the first load platform 204.

When scanning the hologram 22, the hologram 22 is placed on the second load platform 202. When the light source 212 emits a light, the light penetrates the second load platform 202 and the hologram 22 with an incidence F2. The largest effective incidence with which the light is reflected by the hologram 22 and able to pass through the entrance pupil 210a of the chassis 210 is defined as the second maximum scanning incidence Fmax2. Any light with an incidence larger than the second maximum scanning incidence Fmax2 will deviate from the entrance pupil 210a after being reflected so that the projection of the emitted light fails to form any image in the image sensing unit 218. Thus, the scanning incidence F2 is necessary to be smaller than the maximum scanning incidence Fmax2; that is,
F2<Fmax2 (formula 4).

Without regarding to the refractive index of the second load platform 202, the second maximum scanning incidence Fmax2 is substantially equal to arctan[L/2(D+d1+dv+d2)] and smaller than the first maximum scanning incidence Fmax1; that is,
Fmax2□arctan[L/2(D+d1+dv+d2)]<arctan[L/2(D+d1)]□Fmax1

It can be known from these formulas, when the first distance L between the light source 212 and the entrance pupil 210a and the second distance D between the light source 212 and the first load platform 204 are fixed values, the second maximum scanning incidence Fmax2 can be determined by the first thickness d1 of the first load platform 204, the second thickness d2 of the second load platform 202, and the adjustable distance dv between the second load platform 202 and the first load platform 204.

Therefore, during the design and manufacturing process of the scanning apparatus, the second maximum scanning incidence Fmax2 can be controlled to be less than the maximum penetrable incidence Imax by increasing the second distance D between the light source 112 and the load platform 102, increasing the first thickness d1 of the first load platform 204, increasing the second thickness d2 of the first load platform 202, increasing the adjustable distance dv between the first load platform 204 and the second load platform 202, or decreasing the first distance L between the light source 112 and the entrance pupil 110a. Thus, the scanning apparatus according to the invention controls the second maximum scanning incidence Fmax2 to be less than the maximum penetrable incidence Imax by means of the structural design; that is,
Fmax2<Imax (formula 5)

The following formula B can be induced from the above mentioned formula 4 and formula 5:
F2<Fmax2<Imax (formula B)

Therefore, it can be seen from the formula B, the light with the scanning incidence F2 smaller than the maximum penetrable incidence Imax does not reflect the holographic picture. Then the light with scanning incidence F2 even smaller than the second maximum scanning incidence Fmax2 reflects the image to be scanned, passes through the entrance pupil 110a to enter the chassis 200 and reach the reflection mirror set 214, and is then reflected by the reflection mirror set 214 and focused by the lens 216 sequentially so that the image to be scanned is formed in the image sensing unit 218.

Furthermore, the scanning apparatus according to the second embodiment provides dual-scanning mode for scanning a general picture under a first scanning mode and for scanning a hologram under a second scanning mode. As shown in FIG. 2, the first load platform 204 preferably is a scanning glass disposed on the main body 200 while the second load platform 202 preferably is a cover made of glass, acrylics, or other transparent material and rotatably disposed on the main body 200 by pivoting on the revolving spin 206. In particular, values of the second distance D, the first distance L, the first thickness d1 of the first load platform, and the second thickness d2 of the second load platform of a finished scanning product are fixed, the second load platform 202 can be an optional and detachable equipment and the user can easily adjust the adjustable distance dv by himself/herself. Therefore, the second maximum scanning incidence Fmax can be controlled under the second scanning mode according to the maximum penetrable incidences Imax(X) of the holographic pictures X by adjusting the adjustable distance dv; that is,
Fmax2<Imax(X) (formula 6)

The following formula C can be induced from the above mentioned formula 4 and formula 6:
F2<Fmax2<Imax(X) (formula C)

Therefore, it can be seen from the formula C, the light with the scanning incidence F2 smaller than the maximum penetrable incidences Imax(X) of various holographic pictures X does not reflect the holographic pictures X in the holograms.

The scanning apparatus capable of filtering off a holographic picture according to the embodiments of the invention can control the maximum scanning incidence to be less than the maximum penetrable incidence by means of the structural design, thereby directly filtering off the holographic picture in the hologram while scanning and preventing the scanned image from being overlaid with the holographic picture. Appendix 2 shows a scanning result of the identity card using holography. As shown in Appendix 1, the holographic picture with a pattern of “Great Wall” and a word of “CHINA” does not be scanned along with the content of the identity card so that the content of the identity card is clear and distinguishable. Further, the scanning apparatus according to the second embodiment provides dual-scanning mode for scanning a general picture under a first scanning mode and for scanning a hologram under a second scanning mode. The design of dual-scanning mode not only increases the convenience of usage but also provides an easy approach for users to control the maximum scanning incidence under the second scanning mode according to different maximum penetrable incidences Imax(X) of various holographic pictures X by adjusting the adjustable distance dv between the liftable or attachable load platform and the main body. As such, the light can penetrate the laser layer without reflecting the holographic picture in the hologram.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A scanning apparatus capable of filtering off a holographic picture in a hologram, the hologram including an image to be scanned and the holographic picture with a maximum penetrable incidence, the apparatus comprising:
a load platform, for placing a hologram thereon; and
a chassis comprising a light source and a light signal sensing unit, the light source emitting a light with a scanning incidence (F) to penetrate the hologram so that the image to be scanned is reflected and absorbed by the light signal sensing unit;
wherein the scanning incidence (F) is smaller than the maximum penetrable incidence (Imax) of the holographic picture so that the light with the incidence (F) penetrates the hologram to reflect the image to be scanned.

2. The apparatus according to claim 1, wherein the chassis has an entrance pupil and further comprises:
a reflection mirror set;
a lens; and
an image sensing unit,
wherein the light for reflecting the image to be scanned reaches the reflection mirror set by passing through the entrance pupil and then reflected by the reflection mirror and focused by the lens sequentially so that the image to be scanned is formed in the image sensing unit.

3. The apparatus according to claim 1, wherein the load platform is a glass.

4. The apparatus according to claim 1, wherein the load platform is an acrylic sheet.

5. The apparatus according to claim 1, wherein the load platform is made of a transparent material.

6. A scanning apparatus having two load platforms, capable of filtering off a holographic picture in a hologram, the hologram including an image to be scanned and the holographic picture with a maximum penetrable incidence, the apparatus comprising:
a first load platform, for placing a document thereon, the document being different from the hologram and including a further image to be scanned;
a second load platform, disposed above the first load platform, for placing the hologram thereon; and
a chassis comprising a light source for emitting a light;
wherein when a user scans the hologram, the hologram is placed on the second load platform and the light with an scanning incidence (F2) penetrates the hologram so that the image to be scanned is reflected, and wherein the scanning incidence (F2) is smaller than the maximum penetrable incidence (Imax) of the holographic picture.

7. The apparatus according to claim 6, wherein the chassis has an entrance pupil and further comprises:
a reflection mirror set;
a lens; and
an image sensing unit,
wherein the light for reflecting the image to be scanned or the further image to be scanned reaches the reflection mirror set by passing through the entrance pupil and then reflected by the reflection mirror and focused by the lens sequentially so that the image to be scanned or the further image to be scanned is formed in the image sensing unit.

8. The apparatus according to claim 6, wherein the first load platform has a first thickness (d1) and the second load platform has a second thickness (d2), and the second load platform and the first load platform are spaced by an adjustable distance (dv).

9. The apparatus according to claim 8, wherein the adjustable distance (dv) is adjusted according to the maximum penetrable incidence.

10. The apparatus according to claim 6, wherein the second load platform is liftable.

11. The apparatus according to claim 6, wherein the second load platform is detachable.

12. The apparatus according to claim 10, wherein the second load platform is detachable.

13. The apparatus according to claim 6, wherein the first load platform is a glass and the second load platform is a further glass.

14. The apparatus according to claim 6, wherein the first load platform is an acrylic sheet and the second load platform is a further acrylic sheet.

15. The apparatus according to claim 6, wherein the first load platform and the second load platform are made of transparent materials.
